(19) United States
(12) Patent Application Publication
(10) Pub. No.: US 2017/0346521 A1
(43) Pub. Date: Nov. 30, 2017

(54) ELECTRONIC DEVICE WITH ANTENNA CONTROL FUNCTION AND ANTENNA CONTROL METHOD

(71) Applicant: HON HAI PRECISION INDUSTRY CO., LTD., New Taipei (TW)

(72) Inventor: WEI-YU CHEN, New Taipei (TW)

(21) Appl. No.: 15/605,971

(22) Filed: May 26, 2017

(30) Foreign Application Priority Data
May 27, 2016 (CN) 201610360193.0

(51) Int. Cl. H04B 1/3827; H04B 7/0404; H04W 52/28; H04B 1/401; H04W 88/06

(52) U.S. Cl. CPC H04B 1/3838; H04W 52/283; H04B 1/401; H04B 7/0404; H04W 88/06

(57) ABSTRACT

An antenna control method selects as required one of two inbuilt antenna paths for optimal communication and includes a first transmission power of the antenna being acquired from one antenna path when a first and a second switch device are connected, and a second transmission power from a second antenna path when so connected. A determination is made on events or on a periodic basis as to whether the second transmission power is greater than or equal to the first transmission power, and the antenna path with greater power is selected for communication.

### CROSS-REFERENCE TO RELATED APPLICATIONS

This application claims priority to Chinese Patent Application No. 201610360193.0 filed on May 27, 2016, the contents of which are incorporated by reference herein.

### FIELD

The subject matter herein generally relates to antenna technology, and particularly to an electronic device with an antenna control function and an antenna control method.

### BACKGROUND

When a smart mobile terminal such as a smart phone communicates, for example, to access Internet, or dial or answer a call, antennas are used to transmit and receive signals. However, performance of the antennas is easily influenced by external factors, such as blocking by the hand or a metal object in close proximity.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of an electronic device with antenna control function.

FIG. 2 is a schematic view illustrating an exemplary embodiment of an antenna of an electronic device.

FIG. 3 illustrates a flowchart of an exemplary embodiment of an antenna control method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

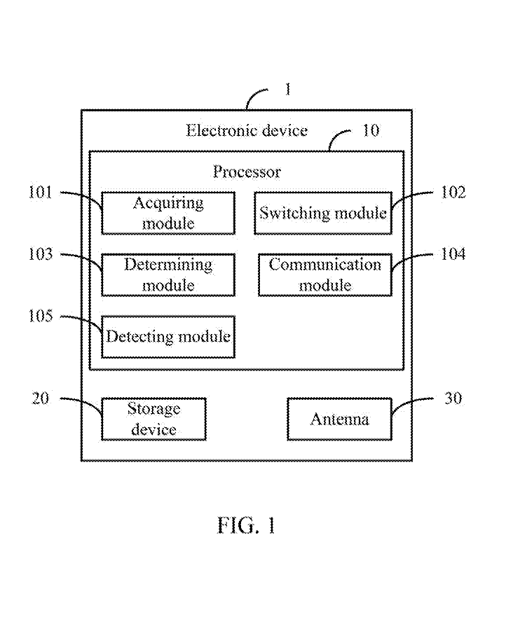

FIG. 1 illustrates an exemplary embodiment of an electronic device 1 with an antenna control function. The electronic device 1 includes, but is not limited to, a processor 10, a storage device 20, and an antenna 30. In at least one exemplary embodiment, the electronic device 1 can be a smart phone or a tablet computer. FIG. 1 illustrates only one example of the electronic device 1, other examples can include more or fewer components than as illustrated, or have a different configuration of the various components in other exemplary embodiments.

In at least one exemplary embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The at least one processor 10 can be a central processing unit (CPU), a microprocessor, or other data processor chip that performs functions of the electronic device 1.

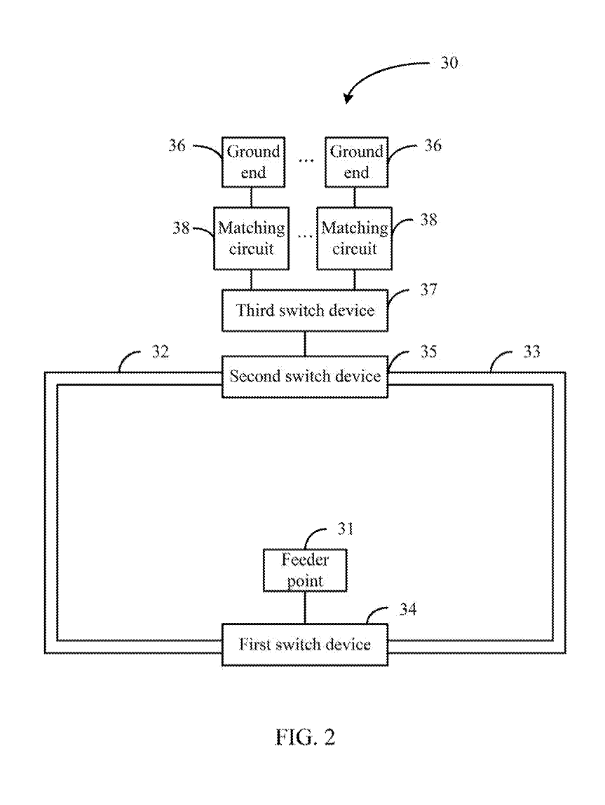

Referring to FIG. 1 and FIG. 2, in at least one exemplary embodiment, the antenna 30 is a loop antenna. The antenna 30 includes, but is not limited to, a feeder point 31, a first antenna path 32, a second antenna path 33, a first switch device 34, a second switch device 35, and a ground end 36. In at least one exemplary embodiment, one end of the first switch device 34 is connected to the feeder point 31, the other end of the first switch device 34 is connected to the first antenna path 32. One end of the second switch device 35 is connected to the ground end 36, the other end of the second switch 35 is connected to the first antenna path 32. In at least one exemplary embodiment, the first switch device 34 and the second switch device 35 can be single-pole, double-throw (SPDT) switches.

In at least one exemplary embodiment, the first antenna path 32 is arranged in a left frame of a shell of the electronic device 1, the second antenna path 33 is arranged in a right frame of the shell of the electronic device 1. When a user holds the electronic device 1 by his right hand, a palm of the user mainly contacts and shields the right frame of the electronic device 1, thereby performance of the second antenna path 33 arranged in the right frame is easily influenced by the right palm of the user. When a user holds the electronic device 1 by his left hand, the palm of the user mainly contacts and shields the left frame of the electronic device 1, thereby performance of the first antenna path 32 arranged in the left frame is easily influenced by the left palm of the user.

As illustrated in FIG. 1, the electronic device 1 includes an acquiring module 101, a switching module 102, a determining module 103, a communication module 104, and a detecting module 105. The modules 101-105 can be collections of software instructions stored in the storage device 20 of the electronic device 1 and executed by the processor 10. The modules 101-105 also can include functionality represented as hardware or integrated circuits, or as software and hardware combinations, such as a special-purpose processor or a general-purpose processor with special-purpose firmware.

In at least one exemplary embodiment, the antenna 30 adopts by default the first antenna path for communication.

When the first switch device 34 and the second switch device 35 are connected to the first antenna path 32, the acquiring module 101 is used to acquire a first transmission power of the antenna 30.

The switching module 102 is used to control the first switch device 34 and the second switch device 35 to switch to the second antenna path 33.

When the first switch device 34 and the second switch device 35 are connected to the second antenna path 33, the acquiring module is further used to acquire a second transmission power of the antenna 30.

The determining module 103 is used to determine whether the second transmission power is greater than or equal to the first transmission power.

When the determining module 103 determines that the second transmission power is greater than or equal to the first transmission power, the communication module 104 is used to control the antenna 30 to adopt the second antenna path 33 for communication.

In at least one exemplary embodiment, when the second transmission power is greater than or equal to the first transmission power, the performance of the first antenna path 32 is indicated as weaker than the performance of the second antenna path 33, due to blocking out or interference by objects.

When the determining module 103 determines that the second transmission power is less than the first transmission power, the switching module 102 is further used to control the first switch device 34 and the second switch device 35 to switch to the first antenna path 32.

The communication module 104 is further used to control the antenna 30 to adopt the first antenna path 32 for communication.

In at least one exemplary embodiment, when the second transmission power is less than the first transmission power, the performance of the second antenna path 33 is indicated as weaker than the performance of the first antenna path 32.

Under adoption of the first antenna path 32 or the second antenna path 33 for communication, the detecting module 105 detects an instant transmission power of the antenna 30. In other exemplary embodiments, the detecting module 105 also can detect the transmission power of the antenna 30 at predetermined time intervals, the predetermined time interval can be one second.

The determining module 103 is further used to determine whether the transmission power of the antenna 30 is reduced according to the transmission power detected by the detecting module 105.

When the determining module 103 determines that the transmission power of the antenna 30 is reduced, if the first switch device 34 and the second switch device 35 are connected to the second antenna path 33, the switching module 102 controls the first switch device 34 and the second switch device 35 to switch to connect to the first antenna path 32 instead, and the communication module 104 control the antenna 30 to adopt the first antenna path 32 for communication. Conversely, the antenna 30 can be changed to adopt the second antenna path 33 for communication.

In at least one exemplary embodiment, when the transmission power of the antenna 30 is reduced, the antenna 30 is changed to adopt another antenna path for communication, thus avoiding deterioration in performance of the antenna 30.

In at least one exemplary embodiment, the antenna 30 further includes a third switch device 37 and a number of matching circuits 38. One end of the third switch device 37 is connected to the second switch device 35, the other end of the third switch device 37 is connected to one of the matching circuits 38. The number of matching circuits are connected to the ground end 36. In at least one exemplary embodiment, the third switch device 37 can be a single-pole multi-throw (SPMT) switch, the matching circuits can be impedance matching circuits which are used for determining a working band of the antenna 30.

In at least one exemplary embodiment, the antenna 30 is connected to one of the number of matching circuits and works in a predetermined band range. When the working band of the antenna 30 needs to be changed, for example, when the electronic device 1 changes carrier operators, the switching module 102 is further used to control the third switch device 37 to switch to a corresponding matching circuit 38, thus, the working band of the antenna 30 can be changed.

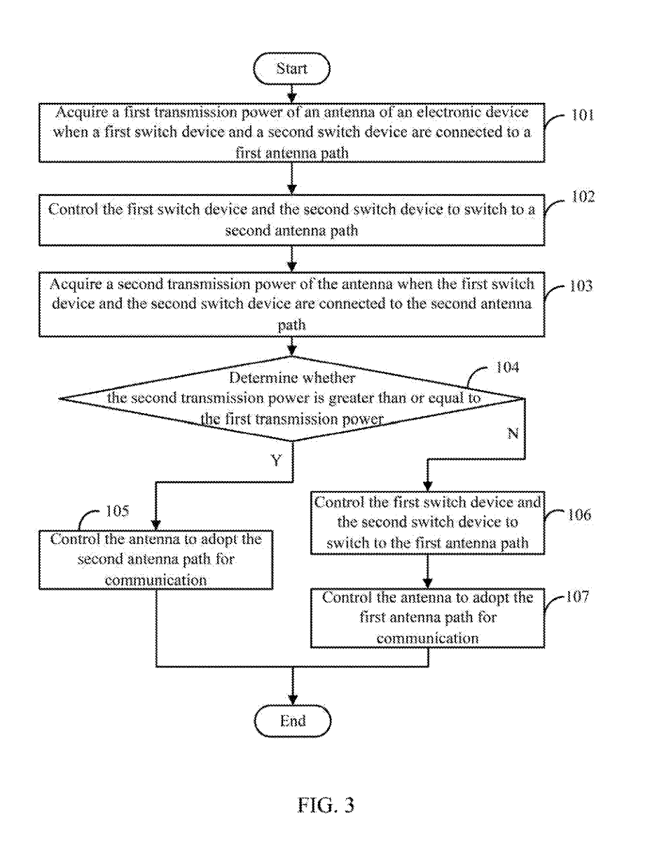

FIG. 3 illustrates a flowchart of an exemplary embodiment of an antenna control method. The method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, when a first switch device and a second switch device are connected to a first antenna path, an acquiring module acquires a first transmission power of an antenna of an electronic device.

At block 102, a switching module controls the first switch device and the second switch device to switch to a second antenna path.

At block 103, when the first switch device and the second switch device are connected to the second antenna path, the acquiring module further acquires a second transmission power of the antenna.

At block 104, a determining module determines whether the second transmission power is greater than or equal to the first transmission power. If the second transmission power is greater than or equal to the first transmission power, the process jumps to block 105. If the second transmission power is less than the first transmission power, the process jumps to block 106.

At block 105, a communication module controls the antenna to adopt the second antenna path for communication.

At block 106, the switching module further controls the first switch device and the second switch device to switch to the first antenna path.

At block 107, the communication module further controls the antenna to adopt the first antenna path for communication.

In at least one exemplary embodiment, the method further includes detecting an instant transmission power of the antenna, determining whether the transmission power of the antenna is reduced according to the detected transmission power, when determining that the transmission power of the antenna is reduced, if the first switch device and the second switch device are connected to the second antenna path, controlling the first switch device and the second switch device to switch to the first antenna path, and controlling the antenna to adopt the first antenna path for communication.

In at least one exemplary embodiment, the method further includes controlling a third switch device to connect to a corresponding matching circuit to change a working band of the antenna.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with an antenna control function comprising:
at least one processor;
an antenna electrically coupled to the at least one processor and comprising a feeder point, a first antenna path, a second antenna path, a first switch device, a second switch device, and a ground end; and
a storage device electrically coupled to the at least one processor and storing instructions for execution by the at least one processor to cause the at least one processor to:
acquire a first transmission power of the antenna when the first switch device and the second switch device are connected to the first antenna path;
control the first switch device and the second switch device to switch to the second antenna path;
acquire a second transmission power of the antenna when the first switch device and the second switch device are connected to the second antenna path;
determine whether the second transmission power is greater than or equal to the first transmission power; and
control, when determining that the second transmission power is greater than or equal to the first transmission power, the antenna to adopt the second antenna path for communication.

2. The electronic device according to claim 1, wherein the at least one processor is further caused to:
control, when determining that the second transmission power is less than the first transmission power, the first switch device and the second switch device to switch to the first antenna path; and
control the antenna to adopt the first antenna path for communication.

3. The electronic device according to claim 1, wherein the at least one processor is further caused to:
detect an instant transmission power of the antenna;
determine whether the transmission power of the antenna is reduced according to the detected transmission power; and
control, when determining that the transmission power of the antenna is reduced, and if the first switch device and the second switch device are connected to the second antenna path, the first switch device and the second switch device to switch to the first antenna path.

4. The electronic device according to claim 1, wherein the antenna further comprises a third switch device and a plurality of matching circuits, one end of the third switch device is connected to the second switch device, the other end of the third switch device is connected to one of the matching circuits, the plurality of matching circuits are connected to the ground end.

5. The electronic device according to claim 4, wherein the at least one processor is further caused to:
control the third switch device to switch to connect to a corresponding matching circuit, thus the working band of the antenna is changed.

6. The electronic device according to claim 1, wherein the first switch device and the second switch device are single-pole, double-throw switches.

7. An antenna control method comprising:
acquiring a first transmission power of an antenna of an electronic device when a first switch device and a second switch device are connected to a first antenna path;
controlling the first switch device and the second switch device to switch to a second antenna path;
acquiring a second transmission power of the antenna when the first switch device and the second switch device are connected to the second antenna path;
determining whether the second transmission power is greater than or equal to the first transmission power; and
controlling the antenna to adopt the second antenna path for communication when determining that the second transmission power is greater than or equal to the first transmission power.

8. The antenna control method according to claim 7, further comprising:
controlling the first switch device and the second switch device to switch to the first antenna path when determining that the second transmission power is less than the first transmission power; and
controlling the antenna to adopt the first antenna path for communication.

9. The antenna control method according to claim 7, further comprising:
detecting an instant transmission power of the antenna;
determining whether the transmission power of the antenna is reduced according to the detected transmission power; and
controlling the first switch device and the second switch device to switch to the first antenna path when determining that the transmission power of the antenna is reduced, and the first switch device and the second switch device are connected to the second antenna path.

10. The antenna control method according to claim 7, wherein the antenna further comprises a third switch device and a plurality of matching circuits, one end of the third switch device is connected to the second switch device, the other end of the third switch device is connected to one of the matching circuits, the plurality of matching circuits are connected to a ground end.

11. The antenna control method according to claim 10, further comprising:
controlling the third switch device to switch to connect to a corresponding matching circuit, thus the working band of the antenna is changed.
